(19) United States
(12) Patent Application Publication
(10) Pub. No.: US 2005/0050781 A1
(43) Pub. Date: Mar. 10, 2005

(54) Image/advertising apparatus and method

(76) Inventors: Douglas A. Duim, Snohomish, WA (US); Rasheed El-Moslimany, Burien, WA (US); Daniel R. Ryan, Issaquah, WA (US)

Correspondence Address: HARNESS, DICKEY & PIERCE, P.L.C., P.O. BOX 828, BLOOMFIELD HILLS, MI, 48303, US

(21) Appl. No.: 10/656,090

(22) Filed: Sep. 5, 2003

(51) Int. Cl. G09F 15/00

(52) U.S. Cl. 40/606.07

(57) ABSTRACT

An advertising system and method in which an advertising mural is segmented and portions of the advertising mural are formed on each one of a plurality of laterally aligned overhead stowage bin doors in a commercial aircraft. Each segment of the advertising mural is furthermore integrally formed with its associated stowage bin door so as to be non-removable therefrom. Thus, an advertising mural can be changed simply and quickly by removing the stowage bin doors making up the mural and replacing them with a different set of stowage bin doors having a different advertising mural formed thereon.

### FIELD OF THE INVENTION

The present invention relates to systems and methods for presenting images, and more particularly to a system and method especially well adapted for use on panels such as stowage bin doors used in an aircraft for presenting enlarged images in the form of multi-section murals, and particularly multi-section advertising murals.

### BACKGROUND OF THE INVENTION

In a commercial aircraft, a plurality of laterally aligned overhead stowage bin doors are typically included along the port and starboard sides of the passenger cabin of the aircraft. Larger commercial aircraft may even have one or more rows of overhead stowage bin doors located along a central area of the passenger cabin between a pair of aisles within the passenger cabin. Each of the stowage bins includes a door which can be raised by a passenger or crew member. The stowage bin doors, when closed, are readily visually apparent to the passengers and crew members within the passenger cabin area of the aircraft.

The stowage bin doors, when in their closed positions, form either relatively flat or only slightly curving surfaces. These doors could advantageously be used for supporting various images, murals or advertising messages. However, up until the present time, it has not been thought to provide laterally adjacent pluralities of stowage bin doors with segmented portions of a single image or advertising mural or message. Providing laterally adjacent stowage bin doors with segmented portions of a single advertising mural or advertising message would provide an opportunity for the airlines to use this space to generate advertising revenue through one or more advertising murals that are not only aesthetically pleasing to view, but unique from the standpoint that the entire advertising message can be presented in a much larger format than if only a single stowage bin door was employed for this purpose. Alternatively, a multi-section image or mural could be used to set a certain theme inside the aircraft.

It would further be advantageous if the segmented portions of an advertising mural could each be integrally formed with their respective stowage bin doors. This would allow the advertising mural to be changed by simply replacing the stowage bin doors with a different set of stowage bin doors that included a different advertising mural. Such a change could easily be effected in a very short time frame so as not to impact the profitability of the airline operating the aircraft.

Accordingly, there still exists a need in the art for presenting an image, an advertising mural or message on a plurality of stowage bin doors on an aircraft to form a multi-section, enlarged advertising mural or image through the use of two or more, laterally adjacent stowage bin doors. There is further a need for a system and method for presenting an enlarged, multi-section image or advertising mural that can be incorporated into the stowage bin doors used on a commercial aircraft, where the image/mural is integrally formed into each stowage bin door, thus enabling different images/murals to be implemented simply by changing the stowage bin doors.

### SUMMARY OF THE INVENTION

The present invention is directed to an image presenting system and method adapted for use with a plurality of adjacently disposed panels on a mobile platform. In one preferred form, the image/mural forms an advertising mural implemented through the use of a plurality of adjacently disposed interior panels on the mobile platform. In one preferred implementation the interior panels comprise overhead stowage bin doors on a mobile platform such as an aircraft. An advertising mural or other form of image or advertising message is segmented into several distinct sections, and the adjacent stowage bin doors are manufactured to each incorporate only one of the segments of the advertising message or mural. When the stowage bin doors are assembled onto the stowage bins, a complete rendition of the advertising mural, image or message is formed. Using a plurality of interior panels, and particularly a plurality of stowage bin doors, to present the image, the advertising mural or message, enables the image, mural or message to be presented in a significantly enlarged form that provides a visually dramatic presentation of the image, mural or message to occupants of the mobile platform.

It is also an important advantage of the present invention that the image/mural is formed on a laminate structure that can easily be integrated, during a subsequent manufacturing step, to form a permanent, integral portion of a structural or interior panel. The laminate structure is especially well suited to form a portion of a stowage bin door. The stowage bin door is constructed with the image, advertising mural or message forming an integral, permanently attached portion thereof. Thus, the image/advertising message or mural can be quickly and easily changed simply by removing one set of stowage bin doors and attaching a different set of stowage bin doors having a different advertising message, mural or image incorporated thereon. Furthermore, there is no need to use adhesives or any solvents to clean the surfaces of the bin doors before the advertising message, mural or image can be changed. This makes the changing of the image or advertising mural easier and more quickly accomplished than with some arrangements that incorporate the use of adhesives for securing the advertising materials to their support panels.

Another important aspect of the present invention involves constructing the stowage bin doors by using a printer to deposit an ink, and more preferably an ultraviolet (UV) curable and stable ink, directly on one layer of material forming a laminate that can easily be incorporated in forming a stowage bin door. More preferably, the ink is deposited directly on one layer of polyvinyl fluoride film (PVF) used in the construction of the laminate. In one preferred implementation the UV curable and stable ink is deposited directly on a layer of Tedlar® PVF. The UV curable and stable ink is cured virtually immediately after being deposited on the Tedlar® PVF by a UV light operably associated with the printer, as the UV light passes over the newly deposited ink The depositing of the UV curable and stable ink directly on the Tedlar® PVF eliminates the need for some type of coating to be formed over the Tedlar® PVF that would be necessary with water and solvent based inks.

### BRIEF DESCRIPTION OF THE DRAWINGS

The present invention will become more fully understood from the detailed description and the accompanying drawings, wherein:

FIG. 1 is a simplified perspective view of a portion of an interior passenger cabin area of a commercial aircraft illustrating an advertising mural incorporated over a plurality of overhead stowage bin doors, in accordance with a preferred embodiment of the present invention;

FIG. 2 is a perspective, enlarged view of one of the stowage bin doors shown in FIG. 1; and

FIG. 3 is a side, cross sectional view of the stowage bin door of FIG. 2 taken in accordance with section line 3-3 in FIG. 2 showing the various layers comprising the bin door.

### DETAILED DESCRIPTION OF THE PREFERRED EMBODIMENTS

The following description of the preferred embodiment(s) is merely exemplary in nature and is in no way intended to limit the invention, its application, or uses.

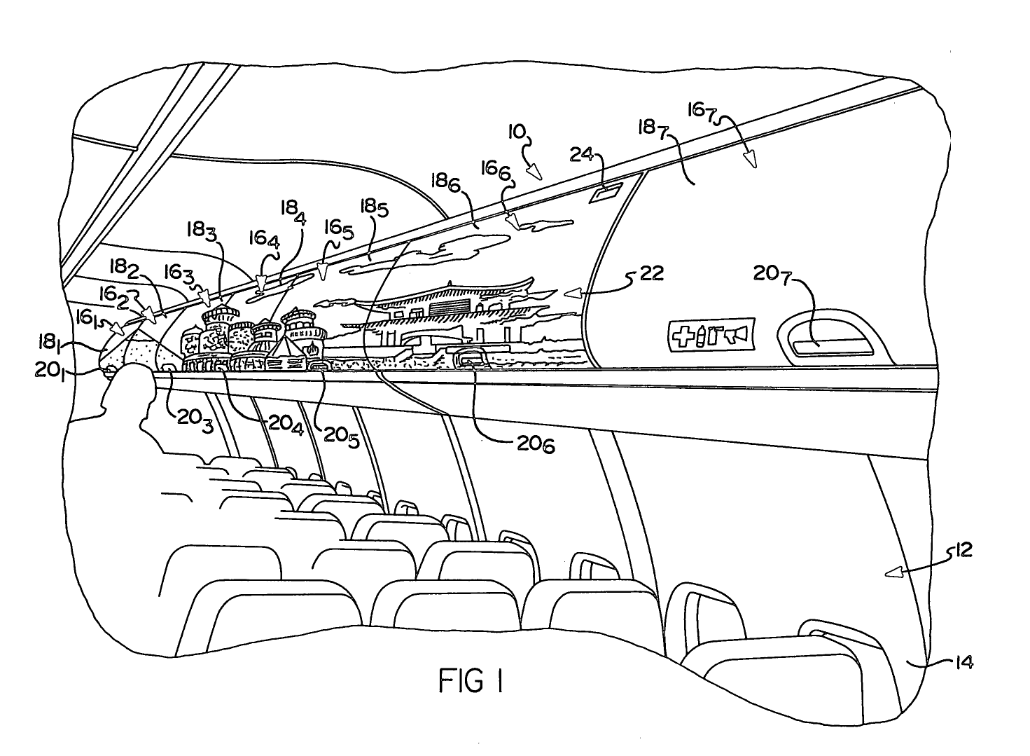

Referring to FIG. 1, there is shown an overhead stowage bin door system 10 in accordance with a preferred embodiment of the present invention. The stowage bin door system 10 is disposed in a passenger cabin area 12 of a commercial aircraft 14. It will be appreciated that most typically, a commercial aircraft will include the stowage bin door system 10 on both the port and starboard sides of the passenger cabin 12. In larger commercial aircraft, such as a twin aisle aircraft, the stowage bin system 10 will also be present over the central area of the cabin (i.e., the area over the seats disposed between the two aisles).

The stowage bin system is comprised of a plurality of independent stowage bin doors 161-16n which are laterally aligned to form a generally continuous overhead storage area. Each stowage bin 161-16n includes an associated bin door 181-18n which may be opened via an associated user-engageable handle 201-20n. The construction of each handle 201-20n is conventional and will therefore not be described. In most instances, at least one stowage bin door 18 near a forward portion of the passenger cabin 12 is left free of any advertising message to comply with FAA regulations that require safety information to be present thereon with no other graphics or indicia that would detract from the noticeability of the safety information. Similarly, at least one bin door close to a midpoint of the passenger cabin area is left clear of advertising indicia, such as indicated by door 187, and typically one stowage bin door 18 at a rear area of the passenger cabin 12 is left free of any advertising material so as not to obfuscate or detract from the visibility of the safety information.

It is a principal advantage of the stowage bin door system 10 that each bin door 181-18n includes a portion (i.e., section) of an enlarged, advertising mural or message, or image which is designated by reference numeral 22. While reference may be made throughout the following text to an “advertising mural” 22, it will be appreciated that this includes any form of image, advertising message or display capable of being segmented into several distinct segments, and is not limited to only advertising images or messages. Since the bin doors 1₈₁-18ₙ are positioned laterally closely adjacent one another, when all of the bin doors are closed, a complete rendition of the single, enlarged image or advertising mural 22 is presented for viewing to the occupants within the passenger cabin 12.

Preferably the image or advertising mural 22 is comprised of vivid colors, although it will be appreciated that the colors employed on the mural 22 could be muted or otherwise selected to match or blend in with the colors of the seats, carpeting, etc. within the passenger cabin area 12. To the occupants within the passenger cabin area 12, the mural 22 appears as a single, generally seamless, image or advertising message. A company logo 24 may be included on each bin door 18 or possibly only on a single one of the bin doors 18 that make up the advertising mural 22. The doors 18 that do not include a segment of the mural 22 form natural “breaks” or dividers which can be used to separate two or more murals.

It will also be appreciated that the use of the bin doors 18 for advertising purposes can represent a means for additional revenue for an airline making use of the system 10 on its aircraft. The enlarged format of each mural 22 further serves to effectively attract and maintain the attention of occupants of the passenger cabin area 12. The mural 22 may also be selected to provide a certain theme within the aircraft, such as an oriental theme, if the aircraft is typically employed for travel to the Orient. Furthermore, depending upon the colors employed, the advertising mural 22 could help to provide a relaxing ambience within the aircraft 14 if the aircraft is employed on relatively long flights.

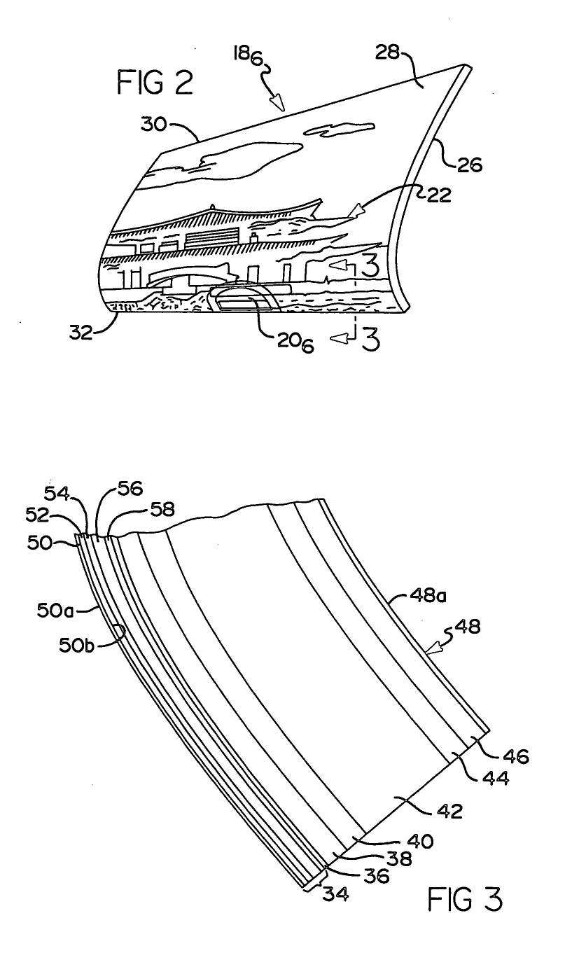

Referring to FIGS. 2 and 3, the construction of each bin door 18 will now be described. Each bin door 18 includes an inner surface 26 and an outer surface 28. The inner surface 26, near an upper edge 30, typically includes one or more hinges (not shown) for enabling the bin door 18 to be secured to its associated storage bin 16. The handle 206 is included along the lower edge 32 so as to be easily accessible by an occupant.

With specific reference to FIG. 3, the construction of the bin door 186 will be described. Each bin door 18 comprises a decorative laminate subsection 34 made up of a plurality of independent layers, that will be described in detail momentarily. The decorative laminate section 34 is disposed against an adhesive layer 36 which may comprise spray or heat activated adhesive. One suitable adhesive is available from Bostic Findley, Inc. This adhesive layer is typically applied with a dry film coverage of 2 to 3 grams/ft2. The adhesive layer 36 is formed on a pre-preg fiberglass layer 38. Pre-preg fiberglass layer 38, in one preferred form, comprises a 120 weave style, although it will be appreciated that other weave styles could also be employed. Pre-preg fiberglass layer 38 is also positioned against a pre-preg fiberglass layer 40. Pre-preg fiberglass layer 40 may comprise a 181 weave style, but again, it will be appreciated that other weave styles could be employed. In addition, there may be small pieces (doublers) of prepreg material placed in key locations to improve surface and/or edge quality.

With further reference to FIG. 3, pre-preg fiberglass layer 40 is positioned against a honeycomb core 42 typically having a thickness in the range of about 0.360 inch-0.500 inch (9.14 mm-12.7 mm). Again, this thickness could be varied. Also, the honeycomb core 42 could be OX formed (i.e., elongated more in the direction normal to the ribbon direction) if desired. Preferably, additional pre-preg layers 44 and 46 are also formed against one another, with layer 44 being formed against the honeycomb core 42. Pre-preg fiberglass layer 44 preferably incorporates a 181 weave style while pre-preg fiberglass layer 46 preferably incorporates a 120 weave style, however, other weave styles could readily be incorporated. Finally, a polyvinyl layer 48 is placed against the pre-preg fiberglass layer 46 to form the inside surface. In one preferred form the polyvinyl layer 48 comprises a layer of Tedlar® PVF (polyvinyl fluoride) film having a thickness of preferably about 2 mills. The Tedlar® PVF layer 48 is also preferably opaque, and more preferably comprises a light color such as white, a light beige or a light grey. An outer surface 48a of the Tedlar® PVF layer essentially forms the inside surface 26 of the bin door and further preferably includes a slight texture which is maintained by the resins in the pre-preg fiberglass layers 46 and 44 once these layers cure during the manufacturing process.

With further reference to FIG. 3, the decorative textured laminate layer 34 will now be described. Layer 34 forms the outer surface 28 of the bin door 186. However, it will be appreciated that laminate 34 could be used to help form a variety of structural or decorative panels able to be used in a mobile platform, or even in a fixed (i.e., non-mobile) structure, and is further not limited to use with only fiberglass pre-preg supporting panels or with a honeycomb support layer. Laminate 34 is comprised of a very thin polyvinyl film 50 having a texture on its outer surface 50a. Film 50, in one preferred form, comprises a Tedlar® PVF film having a thickness of preferably about 1 mill. The Tedlar® PVF film 50 is also preferably a clear gloss or a semi-gloss layer, but in either event it is substantially translucent. Layer 52 represents the ink that comprises the image of advertising mural 22. The ink layer 52 is formed on an inside surface 50b of the polyvinyl film 50. This eliminates the need to place a protective, separate layer over film 50, since film 50, itself, forms a protective covering for the ink on its inside surface 50b. A second polyvinyl film 54 is preferably disposed against the inside surface 50b of PVF film 50. Film 54 also preferably comprises a Tedlar® PVF layer that is preferably white in color to form a suitable background against which the colors of the ink layer 52 stand out. However, it will be appreciated that other colors could be employed depending on the color scheme used in the mural 22. Also, since the ink layer 52 is deposited on the inside surface 50b, it will be appreciated that the image or advertising mural 22 will need to be transposed during the printing process so that it appears correct when being viewed from the opposite side (i.e., outer surface 50a) of layer 50. Alternatively, the ink layer 52 could be formed on the second film 54, which would also eliminate the need to transpose the image during the printing process.

It is an important aspect of the construction of the stowage bin door 18 of the present invention that the ink layer 52 is deposited by a suitable printer, and more preferably by a digital ink jet printer, directly on the Tedlar® PVF film 50. The ink used to form ink layer 52, which makes up the mural 22, preferably comprises an ultraviolet (UV) curable and stable ink (black or colored) that is deposited directly on the Tedlar® PVF film 50. The ink is cured virtually immediately after being deposited by the ink jet printer via a UV light operably associated with the digital ink jet printer that passes over the newly deposited ink as the ink is deposited. The use of UV curable ink allows the ink to be deposited directly on the Tedlar® PVF film 50 (or even on film 54) without the need for some type of receptive coating to be placed over Tedlar® PVF film 50 or 54, which would be necessary with water or solvent based digital ink jet inks. Advantageously, the Tedlar® PVF films 50 and 54 form a fireworthy material that meets Federal Aviation Administration fire safety requirements for materials used on commercial aircraft. The ability of the UV curable ink to be cured virtually immediately after being deposited on the Tedlar® PVF films 50 or 54 also simplifies and expedites the manufacturing of the laminate 34. In addition, UV curable inks allow ink loadings on the Tedlar® PVF in excess of 300% which is difficult, or impossible, to obtain using water or solvent based digital ink jet inks

The decorative textured laminate 34 further includes a layer 56 comprised of an embossing resin and another layer of polyvinyl material 58 which is disposed against the adhesive layer 36. Polyvinyl layer 58 also preferably comprises a Tedlar® PVF material having a thickness of preferably around 2 mills. Layer 58 is also preferably white in color. The layer of embossing resin 56 may vary significantly, but in one preferred form comprises an arial weight of 0.023 lb/ft² to 0.031 lb/ft².

As described above, the ink layer 52 is most preferably applied by a suitable ink jet printer or printing process. Companies making suitable ink jet printers or printing equipment are Vutek of Meredith, N.H. and 3M Corp. of Maplewood, Minn. Other suitable inks are available from Sericol, Inc. of Kansas City, Kans. and Sunjet of Bath, England. The color image formed by the advertising mural 22, in one preferred form, comprises a high contrast color image which is highly aesthetically pleasing to view. The decorative textured laminate 34 is formed in a conventional multi-opening press which uses heat and pressure to laminate the individual layers making up section 34 together as a single, decorative, textured laminate structure. The textured outer surface 50a of the Tedlar® PVF film 50 is maintained by the embossing resin of layer 56 as the resin cures in the multi-opening press during manufacture. The decorative textured laminate section 34 is then combined with the remaining layers 36-48 in a conventional vacuum forming IR oven to form the remainder of the stowage bin door 18. Some trimming of excess material or edge wrapping of laminate section 34 may be required to achieve maximum aesthetic appeal.

It is also an important advantage of the present invention that the mural 22 thus forms an integral portion of each of the bin doors 18 that form the mural 22. Thus, changing of the mural 22 can be accomplished quickly and easily simply by removing the bin doors 18 that have the mural 22 thereon and substituting a different set of bin doors with a different mural. Thus, there is no need to try and remove independent advertising placards from adhesive layers and to reapply new advertising placards. The ability to change the advertising mural without having to deal with adhesives is a significant advantage of the present invention. By integrally forming the mural 22 with each of the bin doors 18, changing of the advertising mural can be accomplished more easily and quickly than with previously developed advertising placards. Thus, there is no need to remove the aircraft from service for an extended period of time simply to change the advertising mural 22.

The apparatus and method of the present invention thus enables images, advertising murals or messages to be implemented using the stowage bin doors of an aircraft in a manner that does not interfere with use of the stowage bin doors, and further that does not interfere with maintenance of the aircraft or with any of the safety designations on various ones of the stowage bin doors. Importantly, the advertising murals contemplated by the present invention form an aesthetically pleasing appearance and can add to the ambience within the passenger cabin area of an aircraft. The present invention is also expected to be an important source of revenue to an airline incorporating the invention on the aircraft it operates.

It will also be appreciated that while the stowage bin doors 18 form a particularly convenient surface for presenting the mural 22, other interior surfaces, such as a ceiling area, could just as readily be employed for the purpose of presenting the mural. Such an area would be more suitable for presenting a mural that is not intended to be changed frequently, whereas the stowage bin doors are ideally suited for murals that will be changed periodically.

The present invention further allows for construction of the stowage bin doors with a designated portion of an image, advertising mural or message printed thereon in a permanent construction. As such, changing of the mural or message can be quickly and easily accomplished by simply changing the stowage bin doors with a different set of doors having a different mural/message. The use of ink jet printing technology to print directly on one of the Tedlar® PVF film layers further simplifies the manufacture of the overall door, while providing a high contrast color image to be formed.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. An apparatus adapted for use in connection with a plurality of functional door panels on a mobile platform for displaying an image, the apparatus comprising:
a first door panel having a first portion of an image;
a second door panel located contiguous to said first door panel and having a second portion of said image;
wherein said first and second portions of said image are not removable from their respective door panels such that a different set of door panels having a different image can be quickly implemented if desired; and
wherein said first and door panels cooperatively form a complete rendition of said image.

2. The apparatus of claim 1, wherein each of said first and second door panels comprises a stowage bin door operatively coupled to a respective stowage bin.

3. The apparatus of claim 1, wherein said image is comprised of a high contrast color image.

4. The apparatus of claim 1, wherein said image comprises an advertising mural.

5. An advertising system adapted for use in connection with a plurality of stowage bin doors on a mobile platform, the system comprising:
a first stowage bin door having a first portion of an advertising mural, said first portion of said advertising mural including a color stable image formed on a first panel associated with said first stowage bin door;
a second stowage bin door having a second portion of said advertising mural, and disposed laterally adjacent and contiguous with said first stowage bin door, and having a color image formed on a first panel associated with said second stowage bin door; and
wherein said first and second portions of said advertising mural cooperatively form a complete rendition of said advertising mural.

6. The system of claim 5, wherein said color stable image comprises at least one ultraviolet (UV) stable color.

7. The system of claim 5, wherein said first panels of each of said first and second stowage bin doors are formed as integral components of their respective stowage bin doors so as to be not removable from said stowage bin doors.

8. An advertising system for use with an interior area of an aircraft, comprising:
a first panel viewable from within a cabin area of said aircraft, said first panel having a first portion of an advertising mural non-removably formed thereon;
a second panel also viewable from within said cabin area and disposed contiguous to said first panel, and having a second portion of said advertising mural non-removably formed thereon;
wherein said first and second panels present said portions of said advertising mural in a manner such that a complete rendition of said advertising mural is presented to an occupant of said aircraft; and
wherein said first and second panels are adapted to be quickly removed so that a different plurality of panels comprising a different mural can be installed within said aircraft.

9. The advertising system of claim 8, wherein each of said first and second panels comprises a door of an associated overhead stowage bin.

10. The advertising system of claim 8, wherein said first and second panels are disposed laterally adjacent one another to form a generally continuous area.

11. The advertising system of claim 8, wherein each said advertising mural forms an integral portion of its associated said panel.

12. A method for presenting an enlarged image within an interior area of an aircraft through the use of laterally aligned stowage bins on the aircraft, the method comprising:
dividing said enlarged image into at least first and second portions;
forming said first portion as a first image on a first door panel of a first one of the stowage bins, wherein said first image is not removable from said first door panel;
forming said second portion of said enlarged image as a second image on a second door panel of a second one of said stowage bins, wherein the second image is not removable from said second door panel;
securing said door panels to laterally adjacent and contiguous stowage bins on said aircraft such that said stowage bin doors provide said images in a manner that forms a complete rendition of said advertising mural.

13. The method of claim 12, wherein forming said first and second portions of said enlarged image comprises forming first and second sections of an advertising mural.

14. The method of claim 13, wherein said first and second portions of said advertising mural comprise ultraviolet stable color images.

15. A method for presenting an advertising mural within an interior area of a mobile platform, the method comprising:
dividing said mural into at least first and second portions;
forming said first portion of said advertising mural as a first image on a first substrate;
using said first substrate to form a portion of a first interior panel for use within said mobile platform;
forming a second portion of said advertising mural as a second image on a second substrate;
using said second substrate to form a second interior panel for use within said mobile platform; and
securing said interior panels adjacent to one another within said mobile platform such that said first and second images present a visually complete rendition of said advertising mural.

16. The method of claim 15, wherein forming said first and second interior panels comprises forming first and second overhead stowage bin doors.

17. The method of claim 15, wherein said advertising mural comprises a ultraviolet stable color image.

18. The method of claim 15, wherein using said substrates to form said first and second interior panels comprises using said substrates to help form stowage bin doors on said mobile platform.
